(19) United States
(12) Patent Application Publication
(10) Pub. No.: US 2016/0180236 A1
(43) Pub. Date: Jun. 23, 2016

(54) FLEXIBLE INPUT SYSTEMS AND METHODS

(71) Applicant: GM GLOBAL TECHNOLOGY OPERATIONS LLC, Detroit, MI (US)

(72) Inventors: CLAUDIA GOLDMAN-SHENHAR, MEVASSERET ZION (IL); OMER TSIMHONI, WEST BLOOMFIELD, MI (US)

(21) Appl. No.: 14/817,320

(22) Filed: Aug. 4, 2015

Related U.S. Application Data
(60) Provisional application No. 62/094,719, filed on Dec. 19, 2014.

(51) Int. Cl. G06N 5/04; G06N 99/00

(52) U.S. Cl. CPC G06N 5/048; G06N 99/005

(57) ABSTRACT

Methods and system are provided for managing user preferences. In one embodiment, a method includes: obtaining information about at least one multi-dimensional user preference; and at least one of generating a recommendation and controlling a system feature based on the multi-dimensional user preference.

### CROSS-REFERENCE TO RELATED APPLICATION

This application claims the benefit of U.S. provisional patent application Ser. No. 62/094,719, filed Dec. 19, 2014, which is hereby incorporated by reference in its entirety.

### TECHNICAL FIELD

The technical field generally relates to methods and systems for managing user preferences, and more particularly to methods and systems for managing multi-dimensional user preferences.

### BACKGROUND

In-vehicle information systems have become commonplace in vehicles such as automobiles, trucks, sport utility vehicles, etc. The information systems typically provide navigation information, entertainment information (e.g., information associated with the radio, CD player, DVD player, etc.), and other information of the vehicle. In some instances, the information systems may be used to configure user preferences. For example, the information systems present options to the user and the user indicates their preferences by selecting one or more of the options.

The options presented in the vehicle (or in other user preference systems) are typically single dimensional. In some cases, multiple options are presented to the user, however, each of the options are single dimensional. For example, in a navigation system, a user may be presented with an option of going the fastest route, or an option of going the shortest route. The single dimensional options may be, for example, binary in nature (e.g., yes, no, avoid, always, etc.), categorical, or a ratio scale (e.g., linear, logarithmic, etc.).

In some cases, a user's preferences may be multi-dimensional. For example, a user may prefer to use the fastest route during a certain time of day and may prefer to go the shortest route at other times of the day. Conventional information systems do not allow for a user to configure multi-dimensional preferences. Accordingly, it is desirable to provide methods and systems for managing multi-dimensional preferences of a user. It is further desirable to provide methods and systems for learning multi-dimensional preferences of a user. In addition, other desirable features and characteristics of the present invention will become apparent from the subsequent detailed description and the appended claims, taken in conjunction with the accompanying drawings and the foregoing technical field and background.

### SUMMARY

Methods and system are provided for managing user preferences. In one embodiment, a method includes: obtaining information about at least one multi-dimensional user preference; and at least one of generating a recommendation and controlling a system feature based on the multi-dimensional user preference.

In another embodiment, a system includes: a first computer module that obtains information about at least one multi-dimensional user preference; and a second computer module that at least one of generates a recommendation and controls a system feature based on the multi-dimensional user preference.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle having a user preferences management system in accordance with various embodiments;

FIGS. 2A, 2B, and 2C are illustrations of graphical user interfaces that may be generated by the user preferences management system in accordance with various embodiments; and

FIGS. 3 and 4 are flowcharts illustrating user preference management methods that may be performed by the user preference management system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

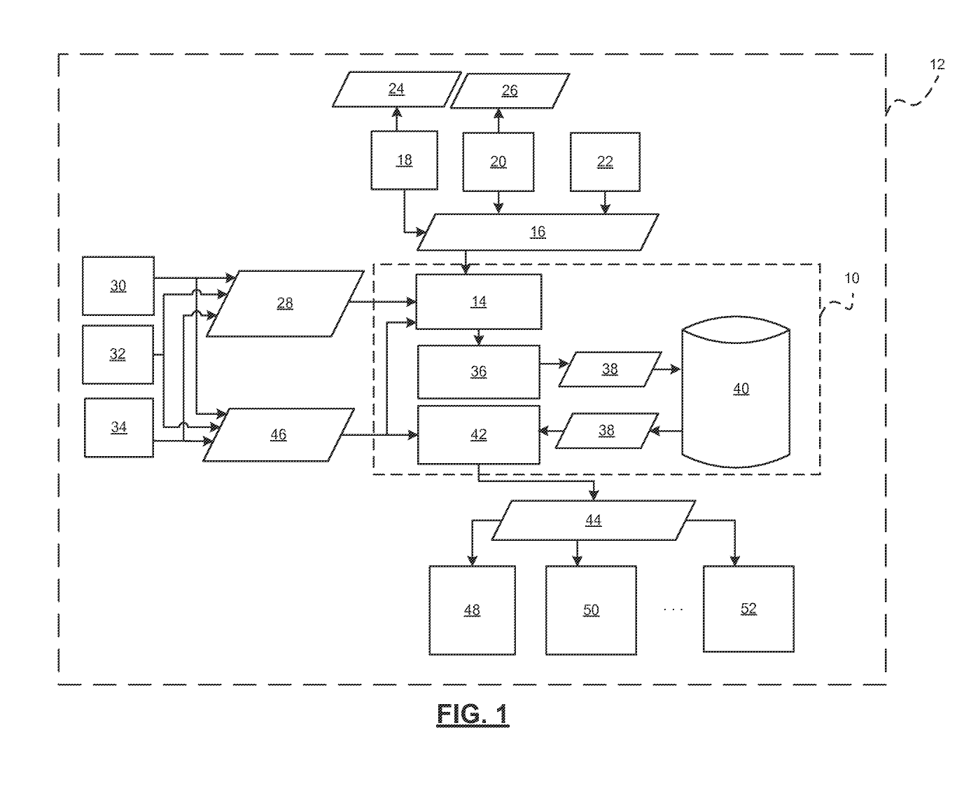

Turning now to FIG. 1, a functional block diagram of a user preferences management system 10 that is implemented within a vehicle 12 is shown in accordance with various embodiments. The vehicle 12 may be an automobile, an aircraft, a spacecraft, a watercraft, a sport utility vehicle, or any other type of vehicle. For exemplary purposes the disclosure will be discussed in the context of the vehicle 12 being an automobile. As can be appreciated, the user preference management systems and methods of the present disclosure are not limited to a vehicle 12, as the methods and systems can be implemented in a variety of information systems or applications that accept user preferences, including but not limited to, query systems, mobile phone applications and settings, web search queries, consumer electronics settings and inputs, television and media settings and inputs, and the like.

As shown in the vehicle example of FIG. 1, the user preferences management system 10 includes one or more input processing modules 14 that obtain information about user preferences from a user. As will be discussed in more detail below, at least some of the information obtained from the user includes information about multi-dimensional preferences. A multi-dimensional preference includes a user's selection of at least two options or at least one fuzzy valued (many values) option. The at least two options are related based on a condition. In various embodiments, the condition is a trade-off between the two options.

The input processing module 14 obtains preference information 16 from the user by way of one or more input/output (I/O) devices 18-22. In various embodiments, the I/O devices 18-22 include, but are not limited to a speech system 18 and/or a display system 20. As can be appreciated, in various embodiments, other types of I/O devices 22 (or input only devices) that receive information about a user's preference from the user may be implemented within the vehicle 12 or may be implemented separate from the vehicle 12 and may communicate with the vehicle (e.g., smartphones, tablets, remote servers, etc.). As can further be appreciated, a single input processing module 14 can be implemented for all of the I/O devices 18-22 (as shown), or alternatively, multiple input processing modules 14 may be implemented, one for each (or a combination of) the I/O devices 18-22.

In various embodiments, the speech system 18 presents preference options to the user by way of a spoken dialog 24 and receives preference information 16 from the user in the form of recorded user speech. The input processing module 14 manages the spoken dialog 24 generated by the speech system 18 to obtain the preference information. The spoken dialog 24 can be managed based on the context of the dialog. The current context may be identified based on context information 46 received from the vehicle 12 or other systems (not shown) associated with the vehicle 12. The context information 46 can be provided by, for example, other control modules 30 in the vehicle 12 (e.g., body control modules, engine control modules transmission control modules, infotainment control modules, etc.), sensors 32 of the vehicle 12, and/or a communication bus 34 or other communication means of the vehicle 12. The speech system 18 processes the recorded user speech to identify the preference information 16 and provides the preference information 16 to the input processing module 14.

At least some of the preference options that are presented to the user via the speech system 18 are multi-dimensional (i.e., having at least two options that are related by a condition or having at least one fuzzy valued option). For example, a sample spoken dialog 24 for a multi-dimensional preference option may include:

SYSTEM: “You have chosen to take the fastest route to work. There is a freeway that will take you in 55 minutes and a toll road that will take you in 50 minutes. Toll will be $4. What do you prefer?”

USER: “Thanks! Today, I am in a hurry to my first meeting with the customers. Let's take the toll road. $4 is nothing compared to the importance of this meeting!”

SYSTEM: “Computing route on toll road to work. Time to arrival 50 minutes at a cost of $4.”

In another example, a sample spoken dialog 24 for a multi-dimensional preference option may include:

SYSTEM: “You have chosen to take the fastest route to work. There is a freeway that will take you in 55 minutes and a toll road that will take you in 50 minutes. Toll will be $4. What do you prefer?”

USER: “Today I am travelling with my family. No rush. No need to pay extra $4 for saving 5 minutes.

SYSTEM: “OK, computing route to destination on freeway. Time to arrival 55 minutes.”

As can be appreciated, these sample spoken dialogs 24 are merely exemplary. In various embodiments, the spoken dialog 24 can be more or less interactive, verbose, or graphical.

In various embodiments, the display system 20 presents preference options to the user by displaying a graphical user interface 26 on a display and receives the preference information 16 from the user in the form of input signals received from a user's interaction with input devices (sensors and/or switches) of the display system 20. The input processing module 14 manages the graphical user interface 26 generated by the display system 20 to obtain the preference information. The graphical user interface 26 can be managed based on the context of the display. The current context may be identified based on context information 46 received from the vehicle 12 or from other systems (not shown) associated with the vehicle 12. The context information 46 can be provided by, for example, the other control modules 30 in the vehicle 12 (e.g., body control modules, engine control modules transmission control modules, infotainment control modules, etc.), the sensors 32 of the vehicle 12, and/or the communication bus 34 or other communication means of the vehicle 12. The display system 20 processes the input signals to identify the preference information 16 and provides the preference information 16 to the input processing module 14.

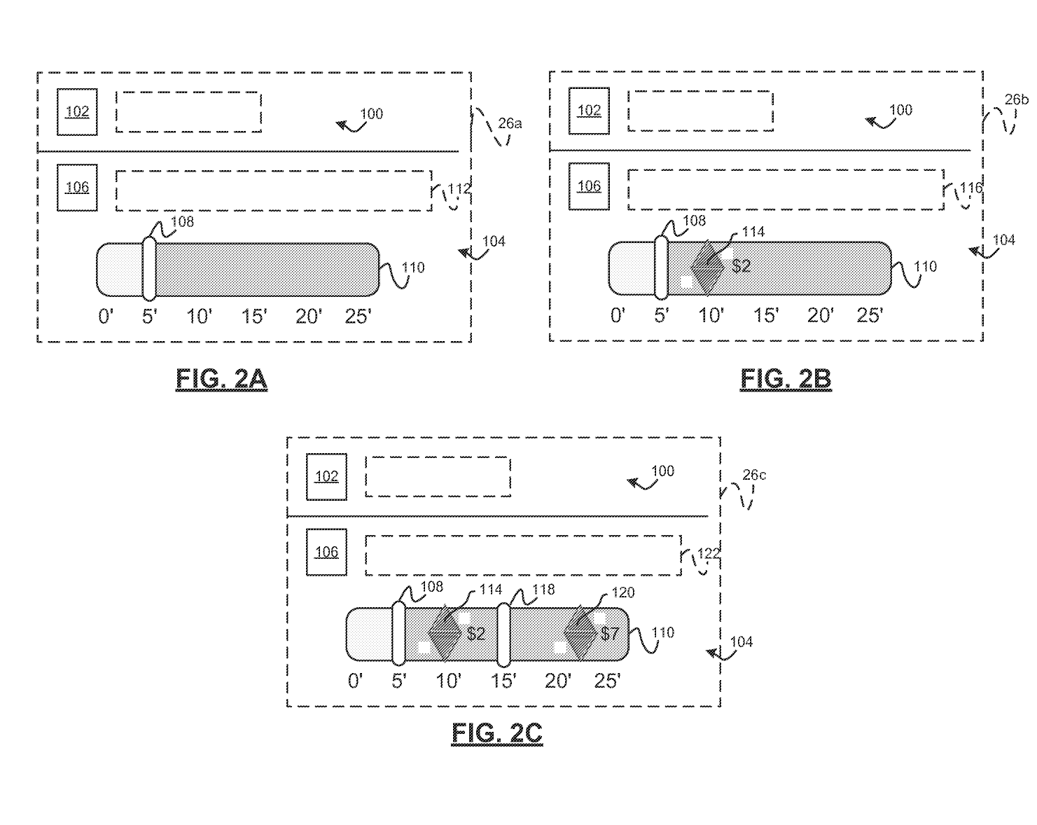

At least some of the preference options that are presented to the user via the display system 20 are multi-dimensional (i.e., having at least two options that are related by a condition or having at least one fuzzy valued option). For example, as shown in FIGS. 2A-2C, exemplary graphical user interfaces 26a-26c are shown that present options for a single dimensional preference option and a multi-dimensional preference option. The graphical user interfaces 26a-26c include options related to a route recommended or a route to be taken. In each of the graphical user interfaces 26a-26c, a fastest option 100 is presented. The fastest option 100 is single dimensional, as the user may select (via the selection box 102) whether or not they prefer a fastest route. In each of the graphical user interfaces 26a-26c, a toll option 104 is presented. The toll options 104 are multi-dimensional.

As shown in FIG. 2A, the toll option 104 is two-dimensional. The first dimension is related to whether or not to use the toll roads and may be selected by the user via the selection box 106. The second dimension is related to a time savings and may be selected by the user via a slider bar 108 along a slider scale 110. The two dimensions of the toll option 104 are related by a condition 112. The condition 112 may be a trade-off between the two dimensions. For example, the condition shown is a trade-off between the use of the tolls and the time savings. Given the selections shown in FIG. 2A, the multi-dimensional preference is, “use tolls only if the savings exceed 5 minutes.”

As shown in FIG. 2B, the toll option 104 is three-dimensional. The first dimension is related to whether or not to use the toll roads and may be selected by the user via the selection box 106. The second dimension is related to a time savings and may be selected by the user via the slider bar 108 along the slider scale 110. The third dimension is related to a cost and may be selected by the user via selection arrows 114. The three dimensions of the toll option 104 are related by a condition 116. The condition 116 may be a trade-off between the three options. For example, the condition shown is a trade-off between the use of the tolls, the use of an amount in tolls, and the time savings. Given the selections shown in FIG. 2B, the multi-dimensional preference is, “use up to $2 in tolls to save at least 5 minutes.”

As shown in FIG. 2C, the toll option 104 is four-dimensional. The first dimension is related to whether or not to use the toll roads and may be selected by the user via the selection box 106. The second dimension is related to a time savings and may be selected by the user via slider bars 108 and 118 along the slider scale 110. The third dimension is related to a first cost limit and may be selected by the user via the selection arrows 114. The fourth dimension is related to a second cost limit and may be selected by the user via the selection arrows 120. The four dimensions of the toll option 104 are related by one or more conditions 122. The conditions 122 may be multiple trade-offs between the four options. For example, the conditions 122 may be trade-offs between the use of the tolls, the time savings, and the toll amount limits. Given the selections shown in FIG. 2C, the multi-dimensional preferences are: “use up to $2 in tolls to save at least 5 minutes;” “use up to $7 in tolls to save at least 15 minutes;” and “ask me about tolls larger than $7.”

As can be appreciated, the dimensions and trade-offs can relate to any aspect of the vehicle or driving. Exemplary dimensions include, but are not limited to, time, cost, distance traveled, parking locations and availability, parking cost, parking type (e.g., covered, etc.), driving maneuvers (e.g., number of left turns, number of right turns, etc.), construction areas, connectivity available on road, type of road, car occupancy, venue availability (e.g., restaurants, rest areas, etc.). As can further be appreciated, the dimensions can be based on discrete values and/or fuzzy values. For example, discrete options can include, dollar amounts, time amounts, distance values, etc. Fuzzy feedback can include, for example, indications such as earlier, faster, a bit more, a bit less, cold, hot etc.

As can be appreciated, the multi-dimensional options may include any number of dimensions. As the number of dimensions increases, typically the complexity of the graphical user interface increases. In various embodiments, to reduce the complexity of presenting the multiple dimensions to the user, one or more of the dimensions of preference options and/or the trade-offs may be learned as will be discussed in more detail below.

With reference back to FIG. 1, in various embodiments, in addition to or as an alternative to the preference information 16 being provided by the user, the input processing module 14 learns preference information 28 about the user based on information received from the vehicle 12. For example, the preference information 28 can be learned from data provided by, for example, the other control modules 30 in the vehicle 12 (e.g., body control modules, engine control modules transmission control modules, infotainment control modules, etc.), the sensors 32 of the vehicle 12, and/or the communication bus 34 or other communication means of the vehicle 12. The input processing module 14 learns the preference information 28 based on, for example, an analysis of the data for repetitive behavior, or for user initiated responses to vehicle initiated activities. In various embodiments, at least some of the preferences learned by the input processing module 14 are multi-dimensional (i.e., having at least two options that are related by a condition or having at least one fuzzy valued option). The learned preference information 28 can be presented to the user for confirmation, for example, via a user interface or a spoken dialog.

As further shown in the vehicle example of FIG. 1, the user preferences management system 10 includes a user model generator module 36. The input processing module 14 provides the received preference information 16, 28 to the user model generator module 36. The user model generator module 36 receives the preference information 16, 28 and creates user models 38 of the user preferences indicated in the preference information 16, 28. The user models 38 store the selected preferences, the learned preferences, and/or predictions of other preferences that are based on the stored and/or learned preferences. For example, given the exemplary interfaces 26a-26c discussed above, the user models 38 can store probability measures related to the chances a user will set a slider to five minutes saving when driving on a weekday to work and there is a meeting in the calendar. The user models 38 are stored in a user model datastore 40. The user model datastore 40 may include volatile or non-volatile memory that temporarily or permanently stores the user models 38.

As further shown in the vehicle example of FIG. 1, the user preferences management system 10 includes at least one preferences processing module 42. The preferences processing module 42 retrieves an appropriate user model 38 (e.g., based on a determination of the current user) and evaluates the user model 38 to determine user preferences 44. The preferences processing module 42 processes the user model 38 based on a current context of the vehicle 12. The current context may be identified based on context information 46 received from the vehicle 12. The context information 46 can be provided by, for example, the other control modules 30 in the vehicle 12 (e.g., body control modules, engine control modules transmission control modules, infotainment control modules, etc.), the sensors 32 of the vehicle 12, and/or the communication bus 34 or other communication means of the vehicle 12.

The preferences processing module 42 provides the user preferences 44 to one or more vehicle systems 48-52. In various embodiments, the vehicle systems 48-52 include, but are not limited to, a navigation system 48, an infotainment system 50, and one or more autonomous driving systems 52. In various embodiments, a single preferences processing module 42 may be implemented for all of the vehicle systems 48-52 (as shown), or alternatively, multiple preferences processing modules 42 may be implemented, one for each (or a combination) of the vehicle systems 48-52.

The vehicle systems 48-52 use the user preferences 44 to provide recommendations to the user, and/or to control certain features of the vehicle 12. At least some of the user preferences 44 provided to the vehicle systems 48-52 are multi-dimensional (i.e., having at least two options that are related by a condition or having at least one fuzzy valued option).

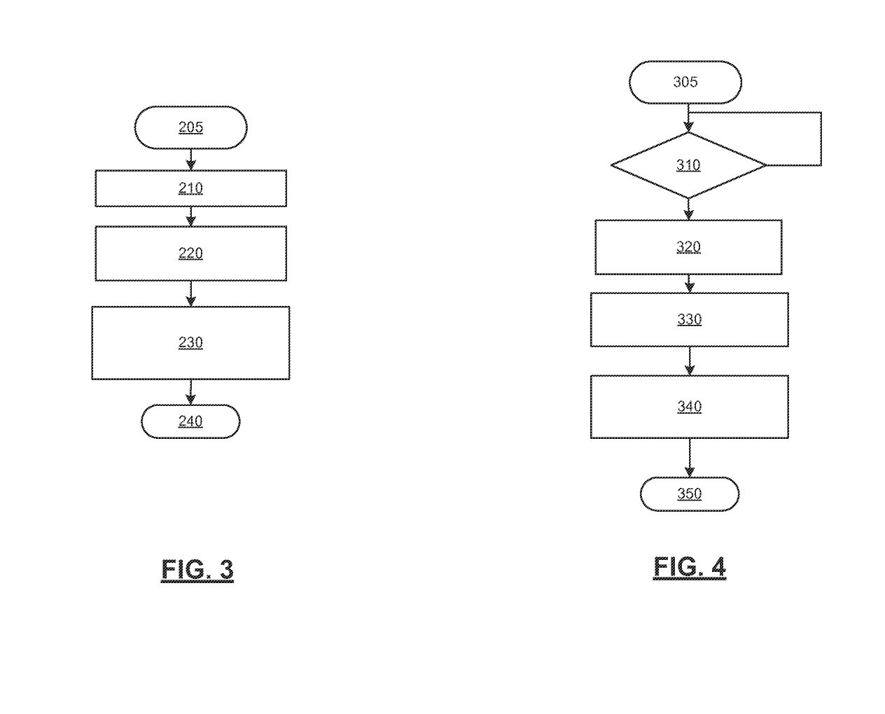

Referring now to FIGS. 3 and 4, and with continued reference to FIG. 1, flowcharts illustrate user preferences management methods that may be performed by the user preferences management system 10 in accordance with various embodiments. As can be appreciated in light of the disclosure, the order of operation within the methods is not limited to the sequential execution as illustrated in FIGS. 3 and 4, but may be performed in one or more varying orders as applicable and in accordance with the present disclosure. As can further be appreciated, one or more steps of the methods may be added or removed without altering the spirit of the method.

As can be appreciated, the methods may be scheduled to run based on an occurrence of a predetermined event or scheduled to run at defined time intervals.

A method of obtaining the preference information 16, 28 and generating the user models 38 is shown in FIG. 3. In various embodiments, the method may begin at 205. The multi-dimensional user preference information 16, 28 is obtained through interaction with the user via the I/O devices 18-22 and/or by learning from the vehicle data at 210. The user model 38 is created for the particular user based on the entered and/or learned multi-dimensional preference information 16, 28 at 220. The user model 38 including the multi-dimensional preferences is stored at 230 for future use. Thereafter, the method may end at 240.

A method of using the user models 38 to make a recommendation and/or control a feature is shown in FIG. 4. The method may begin at 305. It is determined whether a vehicle system 48-52 is requesting user preferences at 310. If a vehicle system 48-52 is not requesting user preferences, the method may continue to monitor for a request for user preferences at 310.

If, however, a vehicle system 48-52 is requesting user preferences at 310, the user model 38 is retrieved for the particular user at 320 and the user preferences are determined for the particular vehicle system 48-52 or feature of the vehicle system 48-52 at 330. The vehicle system 48-52 evaluates the user preferences 44 and makes a recommendation and/or controls a feature of the vehicle 12 based on the user preferences 44 at 340. Thereafter, the method may end at 350.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method of managing user preferences, comprising:
obtaining information about at least one multi-dimensional user preference; and
at least one of generating a recommendation and controlling a system feature based on the multi-dimensional user preference.

2. The method of claim 1, wherein the multi-dimensional option includes at least two options that are related by a condition.

3. The method of claim 2, wherein the condition includes a trade-off between the at least two options.

4. The method of claim 1, wherein the multi-dimensional option includes a fuzzy valued option.

5. The method of claim 1, wherein the information includes at least one dependency between options.

6. The method of claim 1, further comprising:
presenting, by the processor, at least one multi-dimensional option to a user, and wherein the obtaining the information about the at least one multi-dimensional user preference is based on a user's selection of a dimension associated with the at least one multi-dimensional option.

7. The method of claim 1, wherein the obtaining comprises learning, by the processor, at least one multi-dimensional user preference.

8. The method of claim 7, wherein the learning is based on information from a vehicle.

9. The method of claim 7, wherein the learning is based on information from a device associated with a vehicle.

10. The method of claim 1, further comprising:
generating a user model based on the information; and
storing the user model in a datastore.

11. The method of claim 1, wherein the system feature is a vehicle feature.

12. A system of managing user preferences, comprising:
a first computer module that obtains information about at least one multi-dimensional user preference; and
a second computer module that at least one of generates a recommendation and controls a system feature based on the multi-dimensional user preference.

13. The system of claim 12, wherein the multi-dimensional option includes at least two options that are related by a condition.

14. The system of claim 13, wherein the condition includes a trade-off between the at least two options.

15. The system of claim 12, wherein the multi-dimensional option includes a fuzzy valued option.

16. The system of claim 12, wherein the information includes at least one dependency between options.

17. The system of claim 12, further comprising:
a third computer module that presents at least one multi-dimensional option to a user, and wherein the first computer module obtains the information about the at least one multi-dimensional user preference based on a user's selection of a dimension associated with the at least one multi-dimensional option.

18. The system of claim 12, wherein the first computer module obtains the at least one multi-dimensional user preference by learning the at least one multi-dimensional user preference.

19. The system of claim 18, wherein the first computer module learns based on at least one of information from a vehicle, and information from a device associated with the vehicle.

20. The system of claim 12, further comprising a third module that generates a user model based on the information, and that stores the user model in a datastore.
